(19) United States
(12) Patent Application Publication
(10) Pub. No.: US 2021/0289022 A1
(43) Pub. Date: Sep. 16, 2021

(54) PORTABLE ELECTRONIC DEVICE MANAGEMENT SYSTEM AND MANAGEMENT METHOD APPLIED THEREIN

(71) Applicant: Cheng Uei Precision Industry Co., Ltd., New Taipei City (TW)

(72) Inventors: Chin Huang Tseng, New Taipei City (TW); Yi An Tsai, New Taipei City (TW)

(21) Appl. No.: 17/156,643

(22) Filed: Jan. 25, 2021

(30) Foreign Application Priority Data
Mar. 16, 2020 (CN) 202010180945.1

(51) Int. Cl. H04L 29/08; H04L 12/24

(52) U.S. Cl. CPC H04L 67/10; H04L 41/22

(57) ABSTRACT

A portable electronic device management system includes a cloud server, a processing device and a portable electronic device. The cloud server is used to generate and transmit suggestion information. The processing device is set to include a wireless unit, a user interface and a calculation unit. The wireless unit is wirelessly connected with the cloud server and receives the suggestion information. The user interface receives a user input, and the calculation unit executes a calculation process according to the user input to generate and transmit setting information of the portable electronic device. The portable electronic device is set to include a communication module and a storage unit. The portable electronic device receives the setting information of the portable electronic device by virtue of the communication module being connected with the processing device. The storage unit is used for storing usage information.

### CROSS-REFERENCE TO RELATED APPLICATION

The present application is based on, and claims priority from, China Patent Application No. 202010180945.1, filed Mar. 16, 2020, the disclosure of which is hereby incorporated by reference herein in its entirety.

### BACKGROUND OF THE INVENTION

### 1. Field of the Invention

The present invention generally relates to a management system and a management method applied therein, and more particularly to an intelligence portable electronic device management system and a management method applied therein.

### 2. The Related Art

In recent years, in order to prevent people from being exposed to potentially harmful substances, some portable electronic devices in prior art are developed for decreasing the potentially harmful substances. The portable electronic device has a management system and a management method for managing a user's health. The management method is applied in the management system.

The portable electronic device has the management system for simulating an atomizing action. However, in a process of simulating the atomizing action, the potentially harmful substances are apt to affect the user's health.

Therefore, it is necessary to provide a portable electronic device management system, and a management method applied in the portable electronic device management system that allow a user who uses the portable electronic device management system to easily set a health management of the user, and at the same time, the portable electronic device management system, and the management method applied in the portable electronic device management system are helpful for the user to proceed with the health management of the user.

### SUMMARY OF THE INVENTION

An object of the present invention is to provide a portable electronic device management system. The portable electronic device management system includes a cloud server, a processing device and a portable electronic device. The cloud server is used to generate and transmit suggestion information. The processing device is set to include a wireless unit, a user interface and a calculation unit. The wireless unit is wirelessly connected with the cloud server and receives the suggestion information. The user interface receives a user input, and the calculation unit executes a calculation process according to the user input to generate and transmit setting information of the portable electronic device. The portable electronic device is set to include a communication module and a storage unit. The portable electronic device receives the setting information of the portable electronic device by virtue of the communication module being connected with the processing device. The storage unit is used for storing usage information. The portable electronic device transmits the usage information to the processing device from the storage unit to make the user interface be displayed on the usage information. The processing device receives the usage information, and the processing device transmits the usage information to the cloud server to make the cloud server generate the suggestion information according to the usage information, the suggestion information is used in the calculation process.

Another object of the present invention is to provide a management method applied in a portable electronic device management system. Specific steps of the management method applied in the portable electronic device management system are described hereinafter. Store usage information via a storage unit of a portable electronic device of the portable electronic device management system. Display the usage information by virtue of a processing device of the portable electronic device management system being wirelessly connected to the portable electronic device. Receive a user input by the processing device. Execute a calculation process according to the user input. Generate and transmit setting information of the portable electronic device to the portable electronic device to be set by virtue of the processing device. The processing device receives the usage information, and the processing device transmits the usage information to a cloud server of the portable electronic device management system to make the cloud server generate suggestion information according to the usage information, the suggestion information is used in the calculation process.

Another object of the present invention is to provide a management method applied in a portable electronic device management system. Specific steps of the management method applied in the portable electronic device management system are described hereinafter. Store usage information via a storage unit of a portable electronic device of the portable electronic device management system. Display the usage information by virtue of a processing device of the portable electronic device management system being wirelessly connected to the portable electronic device. Execute at least one calculation process of calculation processes of generating setting information of the portable electronic device according to suggestion information, generating the setting information of the portable electronic device according to the user input, and sharing the usage information via a wireless unit of the processing device and according to the user input to acquire the setting information of portable electronic device. Generate and transmit the setting information of the portable electronic device to the portable electronic device to be set by virtue of the processing device. The processing device receives the usage information, and the processing device transmits the usage information to a cloud server of the portable electronic device management system to make the cloud server generate the suggestion information according to the usage information, the suggestion information is used in the at least one calculation process.

As described above, a user is allowed to be self-adjusted, or the user is also able to share the usage information reflecting own usage habits to family members and friends of the user, the medical workers and others to get health suggestion information of the portable electronic device management system, so that the user conveniently sets the portable electronic device, simultaneously, the user is helped to be able to reach a health management purpose. As a result, the management method applied in the portable electronic device management system are helpful for the user to proceed with the health management of the user exactly.

### BRIEF DESCRIPTION OF THE DRAWINGS

The present invention will be apparent to those skilled in the art by reading the following description, with reference to the attached drawings, in which:

FIG. 1 shows a block diagram of a portable electronic device management system in accordance with a preferred embodiment of the present invention;

FIG. 2 shows another block diagram of the portable electronic device management system in accordance with the preferred embodiment of the present invention; and

FIG. 3 shows a flow chart of a management method applied in the portable electronic device management system in accordance with the preferred embodiment of the present invention.

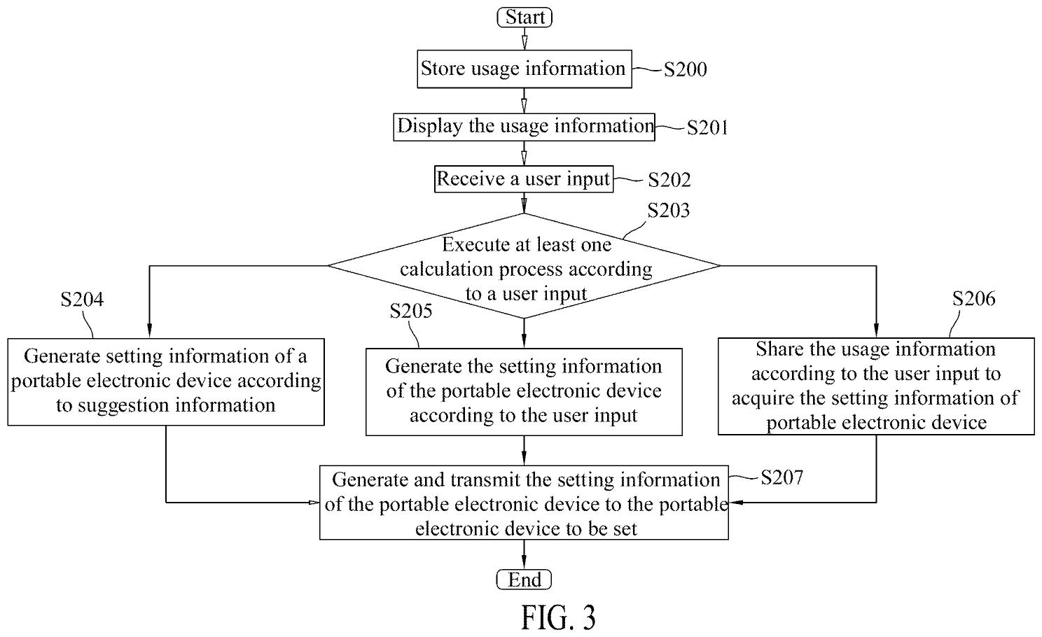

### DETAILED DESCRIPTION OF THE PREFERRED EMBODIMENT

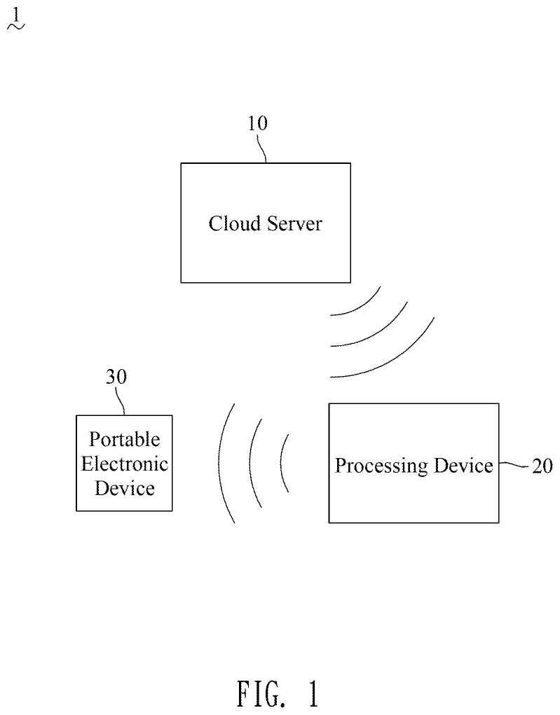

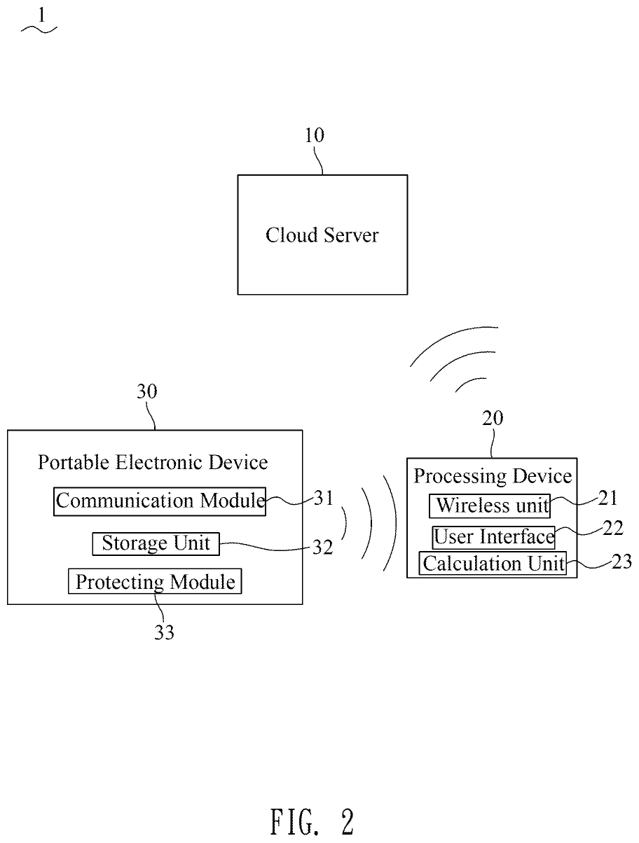

Referring to FIG. 1 and FIG. 2, a portable electronic device management system 1 and a management method in accordance with a preferred embodiment of the present invention are shown. The management method is applied in the portable electronic device management system 1. A block diagram of the portable electronic device management system 1 in accordance with the preferred embodiment of the present invention is shown in FIG. 1. The portable electronic device management system 1 includes a cloud server 10, a processing device 20 and a portable electronic device 30. The processing device 20 is portable. The processing device 20 is carry-on. The portable electronic device management system 1 is carry-on.

The cloud server 10 is used to generate and transmit suggestion information. The processing device 20 is set to include a wireless unit 21, a user interface 22 and a calculation unit 23. The wireless unit 21 is wirelessly connected with the cloud server 10 and receives the suggestion information. The user interface 22 receives a user input, and the calculation unit 23 executes a calculation process according to the user input to generate and transmit setting information of the portable electronic device 30, preferably, the calculation unit 23 executes at least one calculation process according to the user input to generate and transmit setting information of the portable electronic device 30. The portable electronic device management system 1 includes three calculation processes in accordance with the preferred embodiment of the present invention. Quantities of the calculation processes in accordance with the preferred embodiment of the present invention are just illustrated and are without being used to limit the present invention.

The portable electronic device 30 is set to include a communication module 31 and a storage unit 32. The portable electronic device 30 receives the setting information of the portable electronic device 30 by virtue of the communication module 31 being connected with the processing device 20. The storage unit 32 is used for storing usage information. The portable electronic device 30 transmits the usage information to the processing device 20 from the storage unit 32 to make the user interface 22 be displayed on the usage information. The processing device 20 receives the usage information, and the processing device 20 transmits the usage information to the cloud server 10 of the portable electronic device management system 1 to make the cloud server 10 generate the suggestion information according to the usage information. The suggestion information is used in the calculation process. The suggestion information is used in the at least one calculation process. The suggestion information is used in the three calculation processes.

In the preferred embodiment, the portable electronic device 30 further includes a protecting module 33. The portable electronic device 30 is able to be an atomizing device. When the portable electronic device 30 is the atomizing device, the protecting module 33 has a filtering function. The protecting module 33 is detachable and changeable. The protecting module 33 filters fog drops or atomized grains generated by using substances in the portable electronic device 30. The protecting module 33 is also able to filter outside air. Specifically, the protecting module 33 adsorbs harmful substances or potentially harmful substances of the fog drops or the atomized grains of the using substances in the portable electronic device 30, the harmful substances or potentially harmful substances of the fog drops or the atomized grains of the using substances are attached to the protecting module 33. The using substances are able to be oil substances. The protecting module 33 is able to adsorb harmful oil substances or potentially harmful oil substances, and the harmful oil substances or the potentially harmful oil substances are attached on the protecting module 33. The protecting module 33 is able to adsorb dust particles.

Because the harmful substances or the potentially harmful substances of the fog drops or the atomized grains of the using substances are easily frozen, the harmful substances or the potentially harmful substances of the fog drops or the atomized grains of the using substances are apt to be attached on the protecting module 33. The harmful substances or the potentially harmful substances of the fog drops or the atomized grains of the using substances are one of harmful substances or potentially harmful substances which are most easily frozen. The harmful substances or the potentially harmful substances of the fog drops or the atomized grains of the using substances are one of harmful substances or potentially harmful substances which are more easily frozen. The harmful substances or the potentially harmful substances of the fog drops or the atomized grains of the using substances are one of harmful substances or potentially harmful substances which are generally easily frozen.

In the preferred embodiment, the processing device 20 is a mobile phone. The processing device 20 is a smart phone installed with an application program of the portable electronic device management system 1. The processing device 20 which is the smart phone, is paired with and is connected with the portable electronic device 30 via a blue-tooth protocol. The portable electronic device 30 is wirelessly connected to the processing device 20.

In the preferred embodiment, the at least one calculation process is at least one of the three calculation processes. The three calculation processes include a calculation process of generating the setting information of the portable electronic device 30 according to the user input, a calculation process of generating the setting information of the portable electronic device 30 according to the suggestion information and a calculation process of sharing the usage information via the wireless unit 21 and according to the user input. The calculation process is at least one of the calculation process of generating the setting information of the portable electronic device 30 according to the user input, the calculation process of generating the setting information of the portable electronic device 30 according to the suggestion information and the calculation process of sharing the usage information via the wireless unit 21 of the processing device 20 and according to the user input. The at least one calculation process is the at least one of the calculation process of generating the setting information of the portable electronic device 30 according to the user input, the calculation process of generating the setting information of the portable electronic device 30 according to the suggestion information and the calculation process of sharing the usage information via the wireless unit 21 and according to the user input. The three calculation processes are described as follows. Generate the setting information of the portable electronic device 30 according to the user input. Generate the setting information of the portable electronic device 30 according to the suggestion information.

Share the usage information via the wireless unit 21 of the processing device 20 and according to the user input.

Illustrations are described in the preferred embodiment. In the calculation process of generating the setting information of the portable electronic device 30 according to the user input, the calculation unit 23 directly uses the user input as the setting information of the portable electronic device 30. The setting information of the portable electronic device 30 includes a heating voltage and a temperature of the portable electronic device 30. That is to say, a user is able to know the usage information, such as daily usage frequencies or daily usage times of the portable electronic device 30, frequently-used and suggested oil kinds of the portable electronic device 30, the preferred heating voltage of the portable electronic device 30, the preferred temperature of the portable electronic device 30 and other information of the portable electronic device 30 by seeing the usage information displayed on the processing device 20 which is the mobile phone. The portable electronic device 30 is set directly by the application program of the portable electronic device management system 1, the user proceeds with a self-health-management, and a warning and alarming effect is achieved by numerical values which are set by the portable electronic device management system 1.

In the calculation process of generating the setting information of the portable electronic device 30 according to the suggestion information, after the cloud server 10 proceeds with an analysis calculation based on a health management and according to the usage information, the suggestion information which is generated by virtue of the cloud server 10 proceeding with the analysis calculation based on the health management and according to the usage information, is directly used as the setting information of the portable electronic device 30. The setting information of the portable electronic device 30 includes the frequently-used and suggested oil kinds of the portable electronic device 30, the daily usage frequencies or the daily usage times of the portable electronic device 30, the preferred heating voltage of the portable electronic device 30, the preferred temperature of the portable electronic device 30 and other information of the portable electronic device 30. That is to say, the user uploads the usage information stored in the processing device 20 which is the mobile phone to the cloud server 10 via the application program of the portable electronic device management system, the cloud server 10 analyzes and calculates to generate the suggestion information for helping the user to proceed with the health management. In this way, the portable electronic device 30 is set according to the suggestion information, the user is able to reach a health management purpose by use of the daily usage times or the daily usage frequencies, the frequently-used and suggested oil kinds, the preferred heating voltage, the preferred temperature and other information of the portable electronic device 30 which are adjusted and set and according to the acquired suggestion information.

In the calculation process of sharing the usage information via the wireless unit 21 and according to the user input, the calculation unit 23 acquires data for the setting information of the portable electronic device 30 by virtue of sharing the usage information to a network platform set by the user, such as a social software platform, a real-time communication application program sharing platform or etc. That is to say, the user is also able to share the usage information reflecting own usage habits to family members and friends of the user, medical workers and others in real time or in non-real time and by virtue of the social software platform, contact persons of a telephone directory and the real-time communication application program sharing platform, and then more professional and extensive advices are acquired, a setting of the portable electronic device 30 is adjusted by means of the user directly loading the setting information of the portable electronic device 30 via the application program of the portable electronic device management system 1 or the user inputting the setting information of the portable electronic device 30, the setting information of the portable electronic device 30 includes the frequently-used and suggested oil kinds of the portable electronic device 30, the daily usage frequencies or the daily usage times of the portable electronic device 30, the preferred heating voltage of the portable electronic device 30, the preferred temperature of the portable electronic device 30 and other information of the portable electronic device 30, so that the user is able to reach the health management purpose by use of the daily usage times or the daily usage frequencies, the frequently-used and suggested oil kinds, the preferred heating voltage, the preferred temperature and other information of the portable electronic device 30 which are adjusted and set.

Referring to FIG. 1 and FIG. 2 again, a flow chart of the management method applied in the portable electronic device management system 1 in accordance with the preferred embodiment of the present invention is shown in FIG. 2. The management method is able to be applied in the application program of the portable electronic device management system 1. Specific steps of the management method are described as follows.

Step S200: store the usage information via the storage unit 32 of the portable electronic device 30 of the portable electronic device management system 1.

Step S201: display the usage information by virtue of the processing device 20 of the portable electronic device management system 1 being wirelessly connected to the portable electronic device 30. The processing device 20 is the mobile phone, is paired with and is connected with the portable electronic device 30 via the blue-tooth protocol.

Step S202: receive the user input by the processing device 20 which is the mobile phone.

Step S203: execute the calculation process according to the user input, preferably, execute the at least one calculation process according to the user input, specifically, execute the at least one calculation process of the calculation processes of generating the setting information of the portable electronic device 30 according to the suggestion information, generating the setting information of the portable electronic device 30 according to the user input, and sharing the usage information via the wireless unit 21 of the processing device 20 and according to the user input to acquire the setting information of portable electronic device 30.

Preferably, execute the three calculation processes according to the user input, that is to say, in the preferred embodiment, the processing device 20 which is the mobile phone, receives the usage information, and the processing device 20 transmits the usage information to the cloud server 10, so that the cloud server 10 generates the suggestion information according to the usage information, the suggestion information is used in the three calculation processes. Specific steps of executing the three calculation processes are described as follows.

Step S204: generate the setting information of the portable electronic device 30 according to the suggestion information.

Step S205: generate the setting information of the portable electronic device 30 according to the user input.

Step S206: share the usage information via the wireless unit 21 of the processing device 20 and according to the user input to acquire the setting information of portable electronic device 30.

Step S207: generate and transmit the setting information of the portable electronic device 30 to the portable electronic device 30 to be set by virtue of the the processing device 20 which is the mobile phone applying the application program of the portable electronic device management system 1.

The user is able to easily adjust the setting of the portable electronic device 30 through the portable electronic device management system 1 and the management method, and is able to easily store the usage information of the portable electronic device 30 via the processing device 20 paired with the portable electronic device 30 via the blue-tooth protocol. In the preferred embodiment the processing device 20 is the mobile phone, and the user stores the usage information of the portable electronic device 30 to the processing device 20. The user is allowed to easily set the portable electronic device 30 via the processing device 20 which is the mobile phone. The user uploads the usage information, such as the frequently-used and suggested oil kinds of the portable electronic device 30, the daily usage times or the daily usage frequencies of the portable electronic device 30, the preferred heating voltage of the portable electronic device 30, the preferred temperature of the portable electronic device 30 and other information of the portable electronic device 30 stored in the processing device 20 which is the mobile phone to the cloud server 10 by virtue of the portable electronic device 30 being paired with and connected with the processing device 20 which is the mobile phone via the blue-tooth protocol, and then the cloud server 10 analyzes and calculates the usage information to get health suggestion information of the portable electronic device management system 1.

As described above, the user is allowed to be self-adjusted, or the user is also able to share the usage information reflecting the own usage habits to the family members and the friends of the user, the medical workers and others to get the health suggestion information of the portable electronic device management system 1, so that the user conveniently sets the portable electronic device 30, simultaneously, the user is helped to be able to reach the health management purpose. As a result, the management method applied in the portable electronic device management system are helpful for the user to proceed with the health management of the user exactly.

It is obvious for a person having a common knowledge in a related technology field to implement the present invention in other forms which are specific under a condition of being without breaking away from a spirit of the present invention. Therefore, the above-mentioned description should be without being interpreted to a limitation significance in all aspects, whereas, the above-mentioned description should be interpreted to be illustrative.

A range of the present invention should be confirmed by a reasonable explanation of attached claims of the present invention, and all changes in an equivalent range of the present invention are fully included within the range of the present invention.

What is claimed is:

1. A portable electronic device management system, comprising:
a cloud server used to generate and transmit suggestion information;
a processing device set to include a wireless unit, a user interface and a calculation unit, the wireless unit being wirelessly connected with the cloud server and receiving the suggestion information, the user interface receiving a user input, and the calculation unit executing a calculation process according to the user input to generate and transmit setting information of the portable electronic device; and
a portable electronic device set to include a communication module and a storage unit, the portable electronic device receiving the setting information of the portable electronic device by virtue of the communication module being connected with the processing device, the storage unit being used for storing usage information, the portable electronic device transmitting the usage information to the processing device from the storage unit to make the user interface be displayed on the usage information,
wherein the processing device receives the usage information, and the processing device transmits the usage information to the cloud server to make the cloud server generate the suggestion information according to the usage information, the suggestion information is used in the calculation process.

2. The portable electronic device management system as claimed in claim 1, wherein the calculation unit executes at least one calculation process, the at least one calculation process is at least one of three calculation processes, the three calculation processes include a calculation process of generating the setting information of the portable electronic device according to the user input, a calculation process of generating the setting information of the portable electronic device according to the suggestion information and a calculation process of sharing the usage information via the wireless unit and according to the user input.

3. The portable electronic device management system as claimed in claim 2, wherein in the calculation process of generating the setting information of the portable electronic device according to the user input, the calculation unit directly uses the user input as the setting information of the portable electronic device, the setting information of the portable electronic device includes a heating voltage and a temperature of the portable electronic device.

4. The portable electronic device management system as claimed in claim 2, wherein in the calculation process of generating the setting information of the portable electronic device according to the suggestion information, after the cloud server proceeds with an analysis calculation based on a health management and according to the usage information, the suggestion information which is generated by virtue of the cloud server proceeding with the analysis calculation based on the health management and according to the usage information, is directly used as the setting information of the portable electronic device, the setting information of the portable electronic device includes frequently-used and suggested oil kinds of the portable electronic device, daily usage times of the portable electronic device, a preferred heating voltage of the portable electronic device and a preferred temperature of the portable electronic device.

5. The portable electronic device management system as claimed in claim 2, wherein in the calculation process of generating the setting information of the portable electronic device according to the suggestion information, after the cloud server proceeds with an analysis calculation based on a health management and according to the usage information, the suggestion information which is generated by virtue of the cloud server proceeding with the analysis calculation based on the health management and according to the usage information, is directly used as the setting information of the portable electronic device, the setting information of the portable electronic device includes frequently-used and suggested oil kinds of the portable electronic device, daily usage frequencies of the portable electronic device, a preferred heating voltage of the portable electronic device and a preferred temperature of the portable electronic device.

6. The portable electronic device management system as claimed in claim 2, wherein in the calculation process of sharing the usage information via the wireless unit and according to the user input, the calculation unit acquires data for the setting information of the portable electronic device by virtue of sharing the usage information to a network platform set by the user, the setting information of the portable electronic device includes frequently-used and suggested oil kinds of the portable electronic device, daily usage frequencies of the portable electronic device, a preferred heating voltage of the portable electronic device and a preferred temperature of the portable electronic device.

7. The portable electronic device management system as claimed in claim 2, wherein in the calculation process of sharing the usage information via the wireless unit and according to the user input, the calculation unit acquires data for the setting information of the portable electronic device by virtue of sharing the usage information to a network platform set by the user, the setting information of the portable electronic device includes frequently-used and suggested oil kinds of the portable electronic device, daily usage times of the portable electronic device, a preferred heating voltage of the portable electronic device and a preferred temperature of the portable electronic device.

8. The portable electronic device management system as claimed in claim 1, further comprising a calculation process of generating the setting information of the portable electronic device according to the user input.

9. The portable electronic device management system as claimed in claim 1, further comprising a calculation process of generating the setting information of the portable electronic device according to the suggestion information.

10. The portable electronic device management system as claimed in claim 1, further comprising a calculation process of sharing the usage information via the wireless unit and according to the user input.

11. The portable electronic device management system as claimed in claim 1, wherein the portable electronic device further includes a protecting module.

12. The portable electronic device management system as claimed in claim 11, wherein the portable electronic device is able to be an atomizing device, when the portable electronic device is the atomizing device, the protecting module has a filtering function, the protecting module is detachable and changeable, the protecting module filters fog drops or atomized grains generated by using substances in the portable electronic device, the protecting module adsorbs harmful substances or potentially harmful substances of the fog drops or the atomized grains of the using substances in the portable electronic device, the harmful substances or potentially harmful substances of the fog drops or the atomized grains of the using substances are attached to the protecting module, the protecting module is able to adsorb dust particles.

13. The portable electronic device management system as claimed in claim 12, wherein the using substances are able to be oil substances, the protecting module is able to adsorb harmful oil substances or potentially harmful oil substances, and the harmful oil substances or the potentially harmful oil substances are attached on the protecting module.

14. The portable electronic device management system as claimed in claim 1, wherein the portable electronic device management system is carry-on.

15. A management method applied in a portable electronic device management system, comprising steps of:
storing usage information via a storage unit of a portable electronic device of the portable electronic device management system;
displaying the usage information by virtue of a processing device of the portable electronic device management system being wirelessly connected to the portable electronic device;
receiving a user input by the processing device;
executing a calculation process according to the user input; and
generating and transmitting setting information of the portable electronic device to the portable electronic device to be set by virtue of the processing device,
wherein the processing device receives the usage information, and the processing device transmits the usage information to a cloud server of the portable electronic device management system to make the cloud server generate suggestion information according to the usage information, the suggestion information is used in the calculation process.

16. The management method as claimed in claim 15, wherein the calculation process is at least one of a calculation process of generating the setting information of the portable electronic device according to the user input, a calculation process of generating the setting information of the portable electronic device according to the suggestion information and a calculation process of sharing the usage information via a wireless unit of the processing device and according to the user input.

17. The management method as claimed in claim 16, wherein in the calculation process of generating the setting information of the portable electronic device according to the user input, the calculation unit directly uses the user input as the setting information of the portable electronic device, the setting information of the portable electronic device includes a heating voltage and a temperature of the portable electronic device.

18. The management method as claimed in claim 16, wherein in the calculation process of generating the setting information of the portable electronic device according to the suggestion information, after the cloud server proceeds with an analysis calculation based on a health management and according to the usage information, the suggestion information which is generated by virtue of the cloud server proceeding with the analysis calculation based on the health management and according to the usage information, is directly used as the setting information of the portable electronic device, the setting information of the portable electronic device includes frequently-used and suggested oil kinds of the portable electronic device, daily usage times of the portable electronic device, a preferred heating voltage of the portable electronic device and a preferred temperature of the portable electronic device.

19. The management method as claimed in claim 16, wherein in the calculation process of sharing the usage information via the wireless unit and according to the user input, the calculation unit acquires data for the setting information of the portable electronic device by virtue of sharing the usage information to a network platform set by the user, the setting information of the portable electronic device includes frequently-used and suggested oil kinds of the portable electronic device, daily usage times of the portable electronic device, a preferred heating voltage of the portable electronic device and a preferred temperature of the portable electronic device.

20. A management method applied in a portable electronic device management system, comprising steps of:
storing usage information via a storage unit of a portable electronic device of the portable electronic device management system;
displaying the usage information by virtue of a processing device of the portable electronic device management system being wirelessly connected to the portable electronic device;
receiving a user input by the processing device;
executing at least one calculation process of calculation processes of generating setting information of the portable electronic device according to suggestion information, generating the setting information of the portable electronic device according to the user input, and sharing the usage information via a wireless unit of the processing device and according to the user input to acquire the setting information of portable electronic device; and
generating and transmitting the setting information of the portable electronic device to the portable electronic device to be set by virtue of the processing device,
wherein the processing device receives the usage information, and the processing device transmits the usage information to a cloud server of the portable electronic device management system to make the cloud server generate the suggestion information according to the usage information, the suggestion information is used in the at least one calculation process.
